(19) United States
(12) Patent Application Publication
(10) Pub. No.: US 2012/0160338 A1
(43) Pub. Date: Jun. 28, 2012

(54) DRIP LINE INSTALLATION KIT, APPARATUS AND METHOD THEREFOR

(76) Inventors: Joanne PAPARI, Toronto (CA); Hao LI, Etobicoke (CA)

(21) Appl. No.: 13/332,694

(22) Filed: Dec. 21, 2011

(30) Foreign Application Priority Data
Dec. 22, 2010 (CA) 2726210

(51) Int. Cl. F16L 41/04; B23B 41/08

(52) U.S. Cl. 137/15.14; 137/318

(57) ABSTRACT

A drip line installation kit apparatus and method is provided for puncturing a conduit. The kit includes a clamping means having a clamp member to engage the conduit, the clamp member having a guiding channel oriented at a predefined angle to the conduit. A coupling means engages the guiding channel and a punch fits within the coupling means so as to align with the guiding channel and maintain a conduit puncturing punch end at the predefined angle to the conduit. A punch press engages the coupling means and drives the punch into the conduit thereby puncturing the conduit.

### FIELD

The drip line installation kit, apparatus and method described herein relates to dispensing additives directly in a fluid line. More specifically, it relates to a fast and convenient way for installing a collar for automatic dispensing units that dispense additives in supply conduits.

### BACKGROUND

Auto dispensing units have become very common. For example, in the field of sanitation, it is common to add small frequent doses of sanitary solutions in flush lines. Without limiting the scope, the description provided herein concentrates on sanitation applications as sanitation applications expose a wide range of problems. The solutions presented have wide ranging applications to other fields requiring dispensing additives directly into a supply conduit. For example, the benefits may be derived in a wide range of industries ranging from addition of enzymes to addition of minor ingredients during production.

In the sanitation industry, the installation of a drip line to dispense cleaning/de-scaling, disinfecting and/or sanitizing solutions directly in a flush line typically requires the use of an electric drill to install a drip collar on a flush pipe. Such installation is often a time consuming and costly undertaking. Making a small hole on a round wet pipe with a dull drill bit, particularly when the pipe is already installed and cannot be moved, or there is not adequate work space or access to electrical power, is frustrating and often leads to holes being made in undesirable locations on the pipe. There is no room for mistake and making the second hole would result in a leaking pipe.

There is a need to provide drip line installation kit which addresses the above identified concerns.

### SUMMARY

In accordance with a broad aspect, there is provided a drip line installation kit for puncturing a conduit comprising: clamping means to engage the conduit, the clamping means having a clamp member having a guiding channel therethrough, the guiding channel having a longitudinal axis oriented at a predefined angle to the conduit; coupling means to engage the guiding channel, the coupling means having a longitudinal bore therethrough; and a puncturing assembly including: a punch to fit within the longitudinal bore of the coupling means so as to maintain a conduit puncturing punch end at the predefined angle to the conduit; and a punch press to engage the coupling means and the punch to drive the punch into the conduit thereby puncturing the conduit.

In accordance with another aspect, there is provided a method of puncturing a conduit comprising the steps of: engaging the conduit with a clamping means, the clamping means having a clamp member having a guiding channel therethrough, the guiding channel having a longitudinal axis oriented at a predefined angle to the conduit; engaging the guiding channel with a coupling means, the coupling means having a longitudinal bore therethrough; fitting a punch within the longitudinal bore of the coupling means so as to align with the guiding channel and maintain a conduit puncturing punch end at the predefined angle to the conduit; engaging a punch press with the coupling means and the punch; and using the punch press to drive the punch into the conduit, thereby puncturing the conduit.

It is to be understood that other aspects of the drip line installation kit, apparatus and method therefor will become readily apparent to those skilled in the art from the following detailed description, wherein various embodiments are shown and described by way of illustration. As will be realized, the drip line installation kit, apparatus and method therefor is capable of other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

The features and advantages of the drip line installation kit, apparatus and method therefor will become more apparent from the following detailed description of the exemplary embodiments with reference to the attached diagrams wherein like reference numerals indicate similar parts throughout several views. Several aspects are illustrated by way of example, and not by way of limitation, in detail in the figures, wherein:

FIG. 1 is a schematic elevational diagram showing an exemplary supply conduit to which a drip line is to be installed;

FIG. 2 is a schematic elevational break out diagram showing a saddle clamp for the drip line in relation to the supply conduit;

FIG. 3 is a schematic elevational diagram showing a saddle clamp installed on the supply conduit;

FIG. 4 is a schematic elevational diagram showing a coupling affixed to the saddle clamp;

FIG. 5 is a schematic elevational break out diagram showing a conduit puncturing assembly in relation to the saddle clamp;

FIG. 6 is a schematic elevational diagram showing a cutaway view the conduit puncturing assembly;

FIG. 7 is a schematic elevational diagram showing removal of the puncturing assembly;

FIG. 8 is a schematic elevational diagram showing the supply conduit punctured;

FIG. 9 is a schematic diagram showing a cutaway view of an alternative conduit puncturing assembly; and

FIG. 10 is a schematic diagram showing a cutaway view through of yet another conduit puncturing assembly.

### DETAILED DESCRIPTION OF THE EMBODIMENTS

A drip line installation kit is provided for addressing at least some the above identified problems in the art.

The drip line installation kit includes clamping means, coupling means and a conduit puncturing assembly.

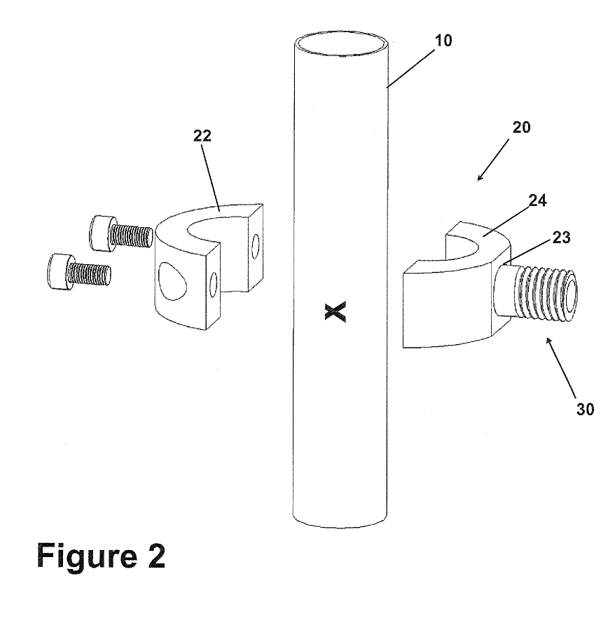

The clamping means provides resilient engagement with a conduit to be punctured. Without limiting the scope of the invention, the clamping means includes a pipe clamp. For example, in accordance with a first embodiment, the pipe clamp is a saddle clamp as shown in FIG. 2 at 20, which may be the same saddle clamp ultimately employed in connecting the drip line (not shown) to the supply conduit 10. The saddle clamp 20 as shown in FIG. 2 includes a split body having symmetric clamp bodies 22, 24.

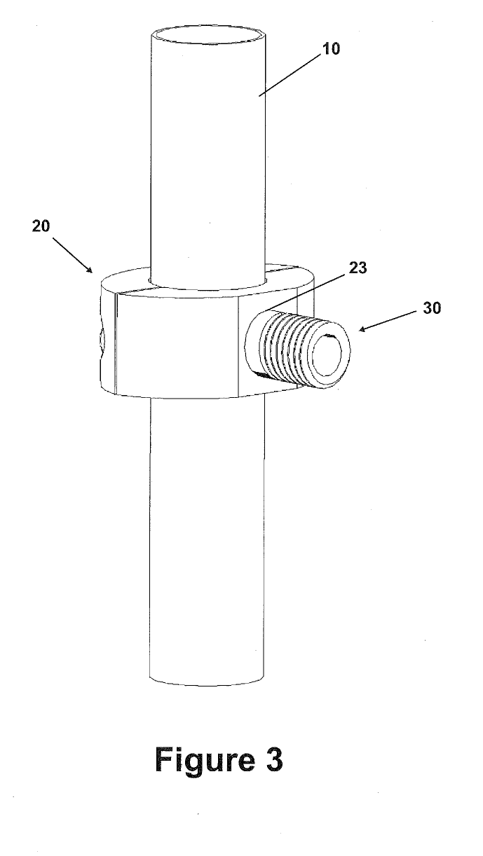

Saddle clamp body 24 typically includes an internal clamp body guiding channel 23 adapted to receive a drip line (not shown). The drip line may be received directly within the clamp body channel or via drip line attachment arrangement such as shown at 30 in FIG. 3.

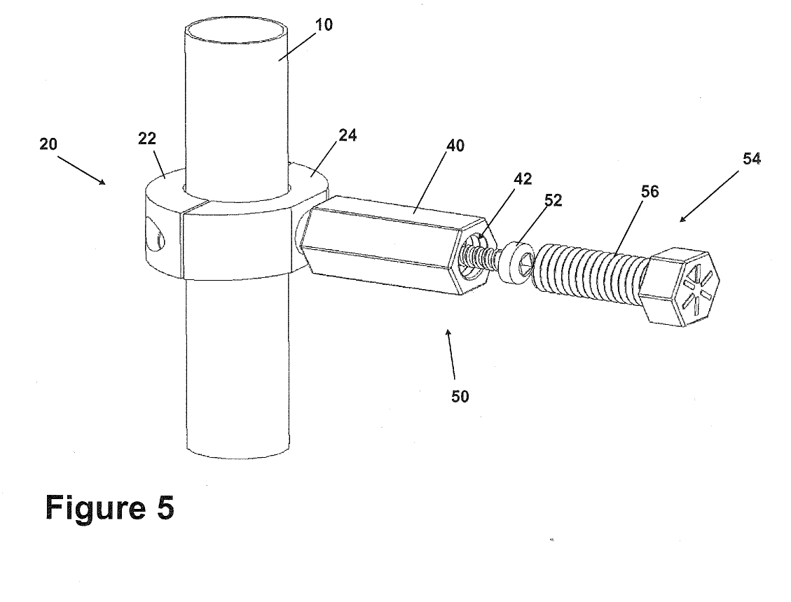

As shown in FIG. 5, a conduit puncturing assembly 50 includes a tubular coupling 40, a punch 52 and a punch press 54.

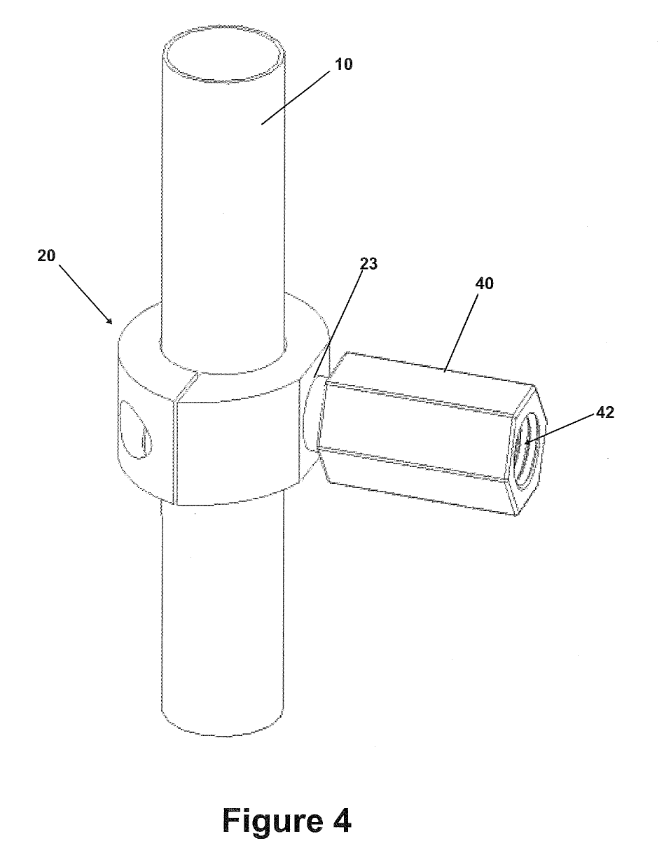

Tubular coupling 40 has a longitudinal bore 42 therethrough (as shown in FIG. 4) and in accordance with the first embodiment presented herein, tubular coupling 40 is adapted to engage the clamp body guiding channel 23 so that the longitudinal bore 42 and the guiding channel 23 are aligned. In accordance with one implementation, clamp body guiding channel 23 has an interior thread and the tubular coupling 40 having a complimentary exterior thread, is adapted to threadingly engage the saddle clamp body guiding channel 23. In the alternative, as shown in FIGS. 3, 4 and 6, the drip line attachment 30 having external threading is used to engage the clamp body guiding channel 23 and facilitate attachment of the tubular coupling 40, which now has internal threading.

A punch is sized to freely pass longitudinally through the longitudinal bore 42 of the tubular coupling 40. The punch is characterized by a tip having a hardness greater than the hardness of the conduit 10 to be punctured. For example, the punch may be substituted with a drill bit, a nail or a screw. A screw punch 52 is shown in FIGS. 5, 6, 7, 9 and 10.

Punch press 54 is employed to mechanically urge punch 52 into conduit 10 by applying a driving force against punch 52. For example, FIGS. 4, 5, and 6 show tubular coupling 40 having a threaded bore 42 and a bolt 56 acting as a punch press. In using a bolt 56 as a punch press 54, tubular coupling 40 and the punch 52 must be sized to permit the bolt 56 to threadingly engage the threaded bore of coupling 40 over a sufficient depth so as to prevent thread damage between the bolt 56 and the threaded coupling bore 42. While other punch press 54 implementations are envisioned to provide substantially the same result of driving the punch through the conduit 10, the use of a screw punch 52 and bolt 56 punch press has been found advantageous from convenience and ease of use perspectives. In particular, a screw punch has the advantage of being easily removable from the conduit 10, once a hole has been made.

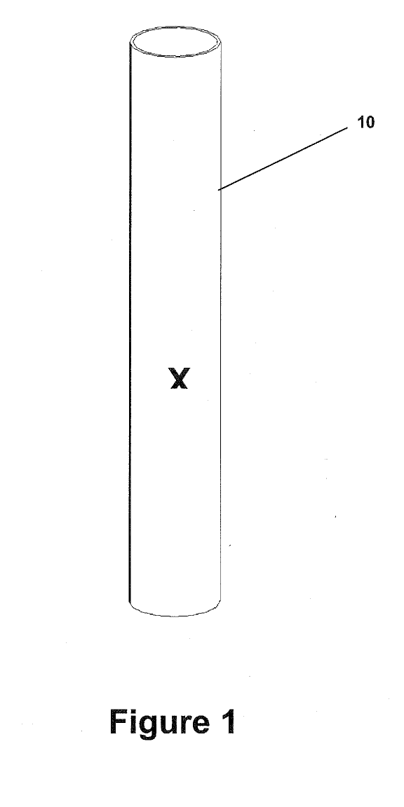

In use, an installer selects a desired location on a supply conduit 10, such as but not limited to a copper pipe, where a drip line is to dispense or inject an additive as shown in FIG. 1. The saddle clamp 20 is installed. If the saddle clamp 20 is the same saddle clamp intended to be employed to ultimately connect the drip line to the supply conduit 10, installation of the saddle clamp 20 prior to supply conduit piercing allows the installer to ascertain appropriate fit.

With the saddle clamp 20 installed, drip line attachment arrangement (hardware) 30, if any, is removed. The removal of drip line attachment hardware leaves clamp body guiding channel 23 free of obstructions. If gaskets are employed in connecting the drip line to the supply conduit, these may have to be removed before installation of the saddle clamp 20 on the supply conduit 10 for puncture in order to prevent gasket damage from any debris or burrs resulting from conduit puncture.

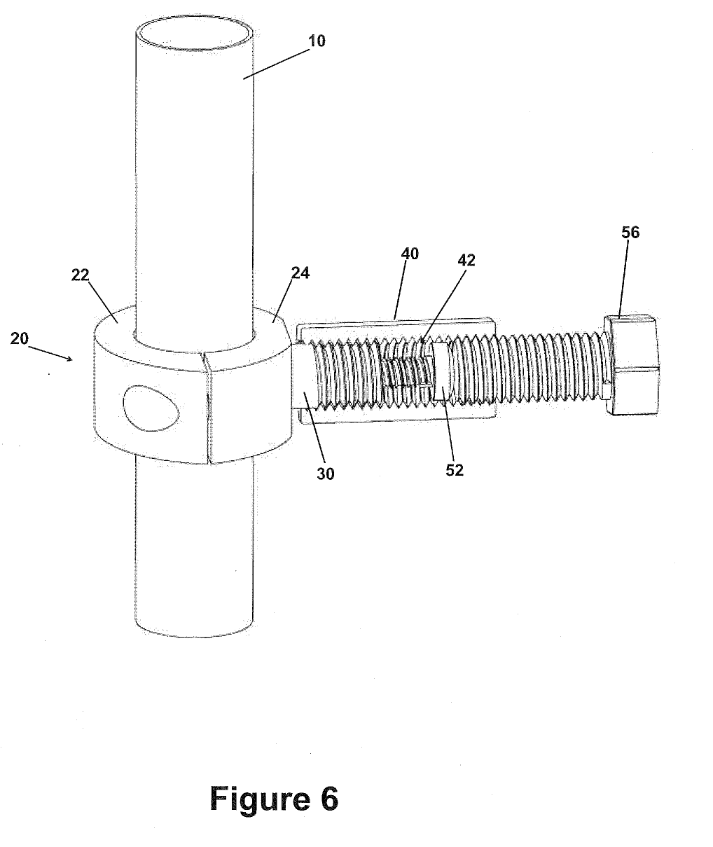

Following the removal of drip line attachment hardware 30, tubular coupling 40 is attached typically in line with the clamp body guiding channel 23. For a threaded saddle clamp body guiding channel 23, coupling 40 is threaded therein, employing external thread. Implementations are envisioned wherein the drip line attachment arrangement 30 includes an external thread about a longitudinal axis of the saddle clamp channel, in such cases the tubular coupling 40 may be attached to such external thread via an internal bore threaded 42 without completely removing the drip line attachment hardware 30 (see FIG. 6).

Following the installation of the coupling 40, screw punch 52 is inserted in the internal bore 42 of coupling 40.

With the screw punch 52 inserted in the coupling 40, the punch press bolt 56 is threadingly engaged into the internal bore 42 of the coupling 40. Tightening the punch press bolt 56 with a suitable wrench provides the necessary force amplification required to cause the screw punch 52 to pierce the conduit 10 as shown in FIG. 6. Tightening the punch press bolt 56 initially experiences increasing resistance followed by a somewhat sharp drop in resistance signaling that the punch has passed through the conduit wall.

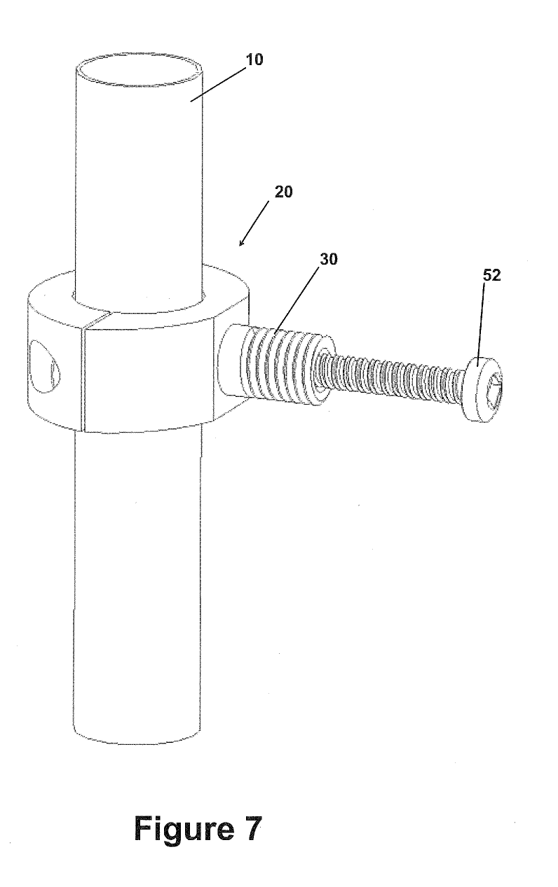

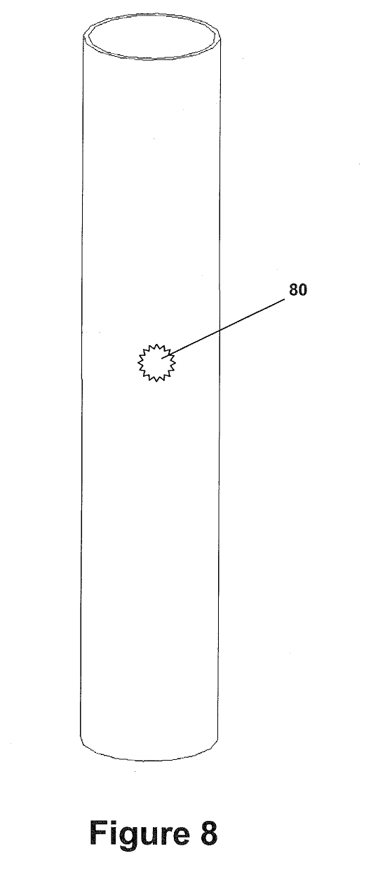

Typically, in piercing the conduit wall the punch 52 gets lodged in the conduit wall. At least the punch press bolt 56 and the coupling 40 may be removed. Depending on the pipe clamp and/or drip line attachment used, the clamp 20 may also have to be removed. Next the punch is removed. In the case of a screw punch 52, as shown in FIG. 7, the screw is simply unscrewed with a screwdriver. Should a larger hole 80 be desired, a screw of a thicker gage may be screwed in to widen it. Alternatively, if safe access to electrical power is available, a drill may be employed using the punched hole as a guide. Preferably the area around the puncture 80 is sanded smooth and any burrs around the puncture hole removed completing the puncturing process as shown in FIG. 8. The final step is to attach the drip line, including replacing any gaskets removed during the piercing stage of the installation.

While using the same pipe clamp for puncturing the conduit and for the eventual drip line connection may be preferred, a person of ordinary skill in the art would understand that not all pipe clamps adapted for connecting drip lines to conduits are well suited for providing the necessary clamping to puncture the conduit.

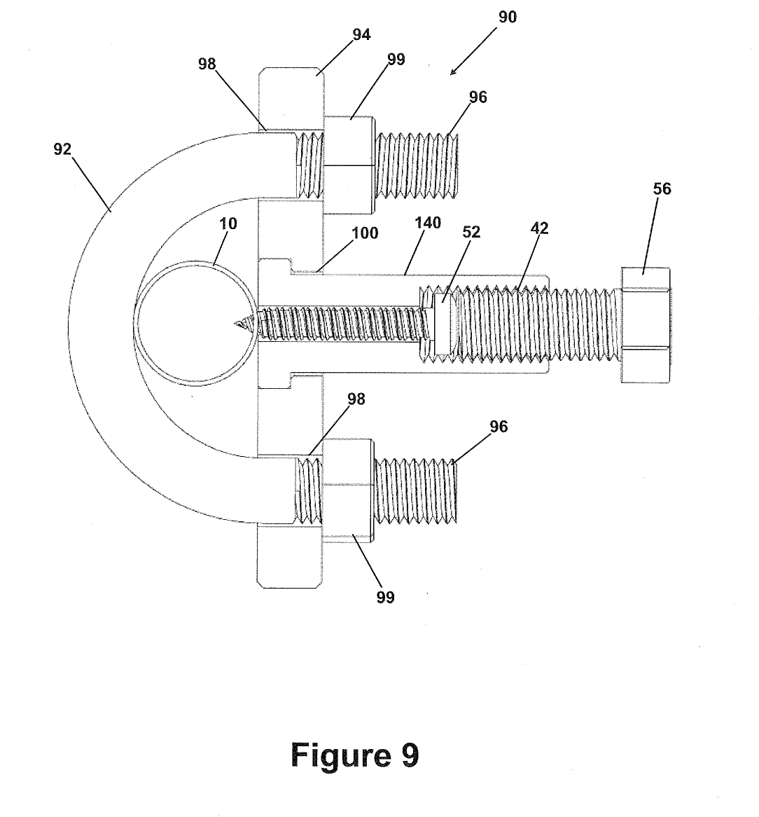

For example, in the first embodiment the saddle clamp 20 is shown to have an inner diameter equal to an outside diameter of conduit 10, such correspondence between the diameters enables use of the same clamp for both puncturing and subsequent drip line installation. In accordance with another embodiment, a U-clamp 90 shown in FIG. 9 may be employed. The U-clamp 90 includes a U-shaped member 92 having an inner diameter and a bar 94. The inner diameter of the U-shaped member 92 is selected to be larger than the outside diameter of the conduit 10 to be punctured. U-clamp 90 may be employed for conduits 10 having a range of outer diameters. The ends 96 of the U-shaped member 92 may be threaded.

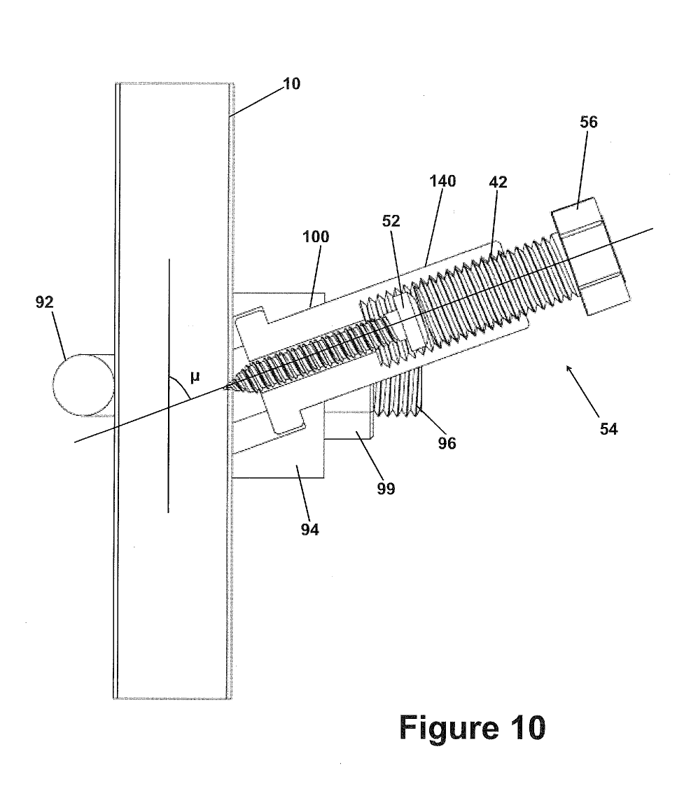

Bar 94 includes a number of apertures. A pair of apertures 98 allow the threaded ends 96 of the U-shaped member 92 to slidably engage the bar 94, a pair of nuts 99 being employed to urge the bar 94 against the U-shaped member 92 thereby providing the clamping action. A central aperture defines a bar guiding channel 100 through the bar 94, which may be formed at a predetermined angle μ with respect to the conduit 10 to be clamped and pierced as shown for example in FIG. 10.

A flanged tubular coupling 140 is slidably engaged in the bar guiding channel 100 with the flange being urged by the bar 94 against the conduit 10. Guiding channel 100 may stepped, as shown in FIGS. 9 and 10, to accommodate the flanges on tubular coupling 140, however, this is not necessary where the flanges are thin. When compared to the first embodiment, the flanged tubular coupling 140 needs to be slidably engaged in the bar guiding channel 100 prior to the clamp 90 installation.

In use, punch 52 is slidably engaged in the coupling 140 and punch press 54 provides the force necessary to drive the punch 52 through the conduit wall. FIGS. 9 and 10 show a screw punch 52. While using a screw is convenient, and has the advantage of being easily removable from the conduit wall once pierced, a large internal bore diameter 42 of the tubular coupling 40/140 in needed to slidably accommodate the screw head within the bore 42. In some cases, depending on the diameter of the conduit 10 relative to the internal diameter of the tubular coupling 40/140, it may be advantageous to use a punch 52 per se. For conduit 10/tubular coupling 40/140 combinations, where the conduit 10 diameter approaches that of the internal diameter of coupling 40/140, guiding of the punch 52 becomes important in order to provide controllable piercing. In determining what a workable “long screw punch” is, in practice it has been noticed that the closer the length of the screw punch 52 is to the inner diameter of coupling bore 42, the more there is a chance for the screw punch 52 to approach the conduit at a skew angle and either provide an undesirably located hole 80 or become lodged in the coupling 40/140. A skew piercing angle error may be minimized by either using a longer screw 52 and therefore a longer tubular coupling 40/140, or a punch per se that is tightly sized and shaped to the bore diameter 42.

The installation kit, apparatus and methods described eliminate the use of a hand drill for the installation of a drip line to a conduit and similar installations. It is fast, sufficiently accurate and convenient way for making a hole on a pipe without using a drill bit. When the drip line clamp is used to puncture the conduit, the methods of piercing the conduit and installing the drip line for dispensing units can be combined saving time.

It is further noted that the herein described apparatus and method is advantageous for making a small hole in a round pipe, particularly when the pipe is already installed and cannot be moved, or there is not adequate work space or access to electrical power and if the pipe is wet and slippery.

The previous detailed description is provided to enable any person skilled in the art to make or use the present drip line installation kit, apparatus and method. Various modifications to the embodiments presented will be readily apparent to those skilled in the art, and the generic principles defined herein may be applied to other embodiments without departing from the spirit or scope of the apparatus and method described herein. Thus, the present drip line installation kit, apparatus and method is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A drip line installation kit for puncturing a conduit comprising:
clamping means to engage the conduit, the clamping means having a clamp member having a guiding channel therethrough, the guiding channel having a longitudinal axis oriented at a predefined angle to the conduit;
coupling means to engage the guiding channel, the coupling means having a longitudinal bore therethrough; and
a puncturing assembly including:
a punch to fit within the longitudinal bore of the coupling means so as to maintain a conduit puncturing punch end at the predefined angle to the conduit; and
a punch press to engage the coupling means and the punch to drive the punch into the conduit thereby puncturing the conduit.

2. The drip line installation kit of claim 1, wherein the conduit comprises a tubular conduit.

3. The drip line installation kit of claim 1, wherein the predetermined angle orients a longitudinal axis of the coupling means substantially perpendicular to the conduit.

4. The drip line installation kit of claim 1, wherein the clamping means comprises a pipe clamp.

5. The drip line installation kit of claim 4, wherein the pipe clamp comprises a saddle clamp.

6. The drip line installation kit of claim 5, wherein the saddle clamp includes the guiding channel.

7. The drip line installation kit of claim 6, further comprising a drip line attachment arrangement for sealingly connecting the guiding channel to the drip line.

8. The drip line installation kit of claim 1, wherein the guiding channel comprises a guide channel screw thread and the coupling means comprises a tubular member having a tubular member screw thread for threadingly engaging the guiding channel screw thread.

9. The drip line installation kit of claim 8, wherein the guiding channel screw thread is internal or external.

10. The drip line installation kit of claim 1, wherein the coupling means is a flanged tubular member, the flange being oversized with respect to the guiding channel.

11. The drip line installation kit of claim 1, wherein the punch comprises a high hardness punch, wherein the hardness of the punch is greater than that of the conduit.

12. The drip line installation kit of claim 11, wherein the punch is selected from the group consisting of a screw, a nail or a drill bit.

13. The drip line installation kit of claim 1, wherein the punch press comprises a screw threaded bolt and the longitudinal bore of the coupling means comprises a screw thread, the bolt threadingly engaging the longitudinal bore of the coupling means.

14. A method of puncturing a conduit comprising the steps of:
engaging the conduit with a clamping means, the clamping means having a clamp member having a guiding channel therethrough, the guiding channel having a longitudinal axis oriented at a predefined angle to the conduit;
engaging the guiding channel with a coupling means, the coupling means having a longitudinal bore therethrough;
fitting a punch within the longitudinal bore of the coupling means so as to align with the guiding channel and maintain a conduit puncturing punch end at the predefined angle to the conduit;
engaging a punch press with the coupling means and the punch; and
using the punch press to drive the punch into the conduit, thereby puncturing the conduit.

15. The method of claim 14, wherein the guiding channel comprises a guide channel screw thread and the coupling means comprises a tubular member having a tubular member screw thread for threadingly engaging the guiding channel screw thread.

16. The method of claim 15, wherein the guiding channel screw thread is internal or external.

17. The method of claim 14, wherein the coupling means is a flanged tubular member, the flange being oversized with respect to the guiding channel.

18. The method of claim 14, wherein the punch press comprises a screw threaded bolt and the longitudinal bore of the coupling means comprises a screw thread, the bolt threadingly engaging the longitudinal bore of the coupling means.
